(19) United States
(12) Patent Application Publication
(10) Pub. No.: US 2008/0034544 A1
(43) Pub. Date: Feb. 14, 2008

(54) Support device

(75) Inventor: Ping Hung Kuo, Taipei (TW)

Correspondence Address: BACON & THOMAS, PLLC, 625 SLATERS LANE, FOURTH FLOOR, ALEXANDRIA, VA, 22314, US

(73) Assignee: TECO IMAGE SYSTEMS CO., LTD, Taipei (TW)

(21) Appl. No.: 11/606,106

(22) Filed: Nov. 30, 2006

(30) Foreign Application Priority Data
Jul. 10, 2006 (TW) 095125128

(51) Int. Cl. E05D 7/00

(52) U.S. Cl. 16/354

(57) ABSTRACT

A support device for supporting an upper body of an electronic apparatus is disclosed. The electronic apparatus further comprises a lower body, and the upper body pivotally rotates relative to the lower body. The support device comprises a rotating element disposed on the lower body and having a thread surface, a first gear disposed on the upper body, a second gear meshing with the first gear at one side and meshing with the thread surface of the rotating element at another side, a first resistant torque providing element disposed under the rotating element, and a second resistant torque providing element disposed under the first resistant torque providing element. The first resistant torque providing element and the second resistant torque providing element provide resistant torques in counter directions to gradually dissolve the weight load of the upper body during the opening or closing processes, so as to stably support the upper body of the electronic apparatus.

### FIELD OF THE INVENTION

The present invention relates to a support device, and more particularly to a support device applied to an electronic apparatus having a liftable upper body.

### BACKGROUND OF THE INVENTION

With the progress of the electronic technology, an electronic apparatus having multiple functions is developed. Taking the multi-function peripheral (MFP) as an example, since it has multiple functions of copying, faxing, printing and scanning, plural office works can be performed on a single electronic apparatus and the occupied space are greatly decreased. Moreover, the assembling process is easier than before, and the multi-function peripheral (MFP) can be used with the computer through an internet cable, a telephone line and a power cord. Therefore, it becomes a popular product in recent years.

The multi-function peripheral (MFP) generally comprises an auto document feeder (ADF) and an image input device. When the inner engine of the multi-function peripheral (MFP) is going to be maintained or repaired, the auto document feeder (ADF) and the image input device need to be opened. In the prior art, a hinge or a linkage mechanism is mounted at the connection location of the image input device and the multi-function peripheral (MFP). However, since the auto document feeder (ADF) and the image input device are quite heavy, the hinge or the linkage mechanism may not stably support the auto document feeder (ADF) and the image input device, and thus, the auto document feeder (ADF) and the image input device may drop down suddenly, which is dangerous to the user.

Please refer to FIG. 1, which is a schematic view showing the conventional support device on the multi-function peripheral (MFP). As shown in FIG. 1, the conventional support device 1 disposed at the connection location of the upper body 101 and the lower body 102 comprises a hinge 11, a spring 12, an upper cover 13 and a lower cover 14, wherein the spring 12 is sleeved on the hinge 11, and one end of the hinge 11 is fixed to the upper cover 13 and the other end of the hinge 11 is fixed to the lower cover 14. When the upper body 101 of the multi-function peripheral (MFP) is moved upwardly to open or moved down to close, the lengths of the hinge 11 and the spring 12 are simultaneously shortened or lengthened in response to the opening or closing angle of the upper body 101. The lengths of the hinge 11 and the spring 12 can be changed due to their flexibility, and a resistant torque is generated therewith to support the upper body 101 of the multi-function peripheral.

The occupied volume and area of the support device should be small to comply with the size of the multi-function peripheral (MFP). Therefore, the sizes and lengths of the hinge 11 and the spring 12 would be limited, and the generated resistant torque would also be limited accordingly. When the weight of the upper body 101, especially the heavy auto document feeder (ADF) and the image input device, is over the threshold, the support device cannot support the upper body 101 well and the upper body 101 may drop down suddenly. As a result, the inner electronic elements may be damaged, and it is also dangerous to the user.

Therefore, it is required to provide an improved support device to overcome the defects of the above described prior art.

### SUMMARY OF THE INVENTION

An object of the present invention is to provide a support device for stably support an upper body of an electronic apparatus to prevent the upper body from dropping down suddenly during the opening or closing process of the upper body.

According to an aspect of the present invention, there is provided a support device for supporting an upper body of an electronic apparatus, wherein the electronic apparatus further comprises a lower body, and the upper body pivotally rotates relative to the lower body. The support device comprises a rotating element disposed on the lower body and having a thread surface, a first gear disposed on the upper body, a second gear meshing with the first gear at one side and meshing with the thread surface of the rotating element at another side, a first resistant torque providing element disposed under the rotating element, and a second resistant torque providing element disposed under the first resistant torque providing element. The first resistant torque providing element and the second resistant torque providing element provide resistant torques in counter directions.

Preferably, the first gear and the second gear have counter rotation directions.

Preferably, the thread surface of the rotating element is a continuous thread surface.

In an embodiment, the first resistant torque providing element is a spring, and the second resistant torque providing element is also a spring.

In an embodiment, the support device further comprises a control collar disposed between the first resistant torque providing element and the second resistant torque providing element. An end of the first resistant torque providing element close to the second resistant torque providing element is fixed to the control collar, and an end of the second resistant torque providing element close to the first resistant torque providing element is fixed to the control collar.

In an embodiment, the first resistant torque providing element is a friction disk and the second resistant torque providing element is also a friction disk.

In an embodiment, the first resistant torque providing element and the second resistant torque providing element are superimposedly and alternatively disposed.

In an embodiment, the first resistant torque providing element is fixed to an axis of the rotating element. In another embodiment, the second resistant torque providing element is fixed to an axis of the rotating element.

In an embodiment, the first resistant torque providing element or the second resistant torque providing element is a spiral spring.

In an embodiment, the support device further comprises a supporting frame disposed under the second resistant torque providing element.

For example, the upper body of the electronic apparatus is an auto document feeder, an image input device, a dust cover or a combination thereof.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view showing the conventional support device on the multi-function peripheral (MFP);

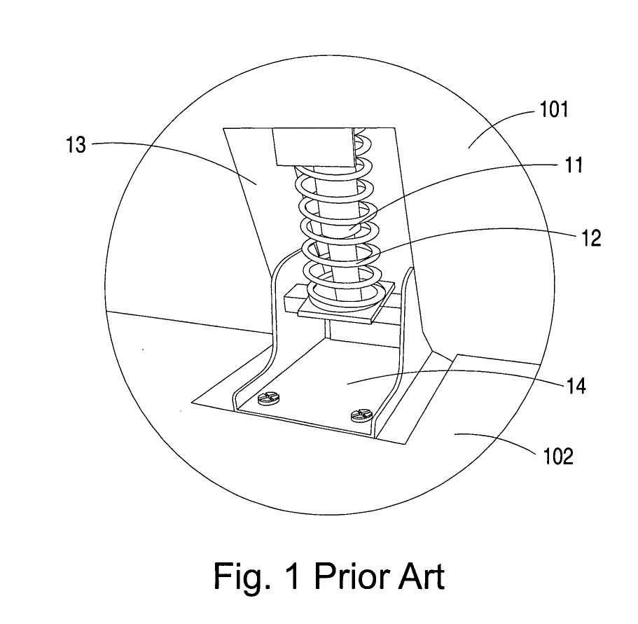

FIG. 2 is a schematic view showing the support device according to the first preferred embodiment of the present invention;

FIG. 3 is a partial enlargement view of FIG. 2;

FIG. 4 is a schematic view showing the support device according to the second preferred embodiment of the present invention; and

FIG. 5 is a schematic view showing the support device according to the third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention discloses a support device for supporting the weight of an upper body of an electronic apparatus, so as to prevent the upper body from dropping down suddenly during the opening and closing processes of the upper body and to further protect the electronic elements in the upper body. The support device can be extensively applied to an office machine, such as a copy machine, a fax machine, a scanner, a multi-function peripheral or similar electronic apparatus in the similar field.

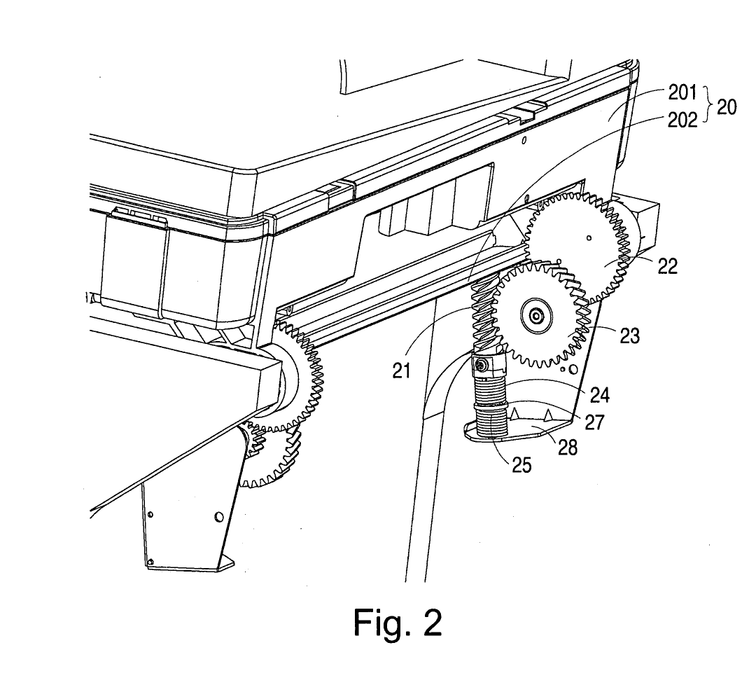

Please refer to FIG. 2, which is a schematic view showing the support device according to the first preferred embodiment of the present invention. The electronic apparatus 20 comprises an upper body 201 and a lower body 202, and the upper body 201 can pivotally rotates relative to the lower body 202. The support device comprises a rotating element 21, a first gear 22, a second gear 23, a first resistant torque providing element 24 and a second resistant torque providing element 25. The rotating element 21 is a worm, for example, which is fixed to the lower body 202 of the electronic apparatus 20 and has a continuous thread surface. The first gear 22 is fixed to the upper body 201 of the electronic apparatus 20, and the second gear 23 meshes with the first gear 22 at one side and meshes with the continuous thread surface of the rotating element 21 at another side. The first resistant torque providing element 24 is disposed under the rotating element 21 and provides a first resistant torque toward a specific direction, and the second resistant torque providing element 25 is disposed under the first resistant torque providing element 24 and provides a second resistant torque toward a specific direction. For example, the first resistant torque providing element 24 and the second resistant torque providing element 25 are springs, such as clutch springs.

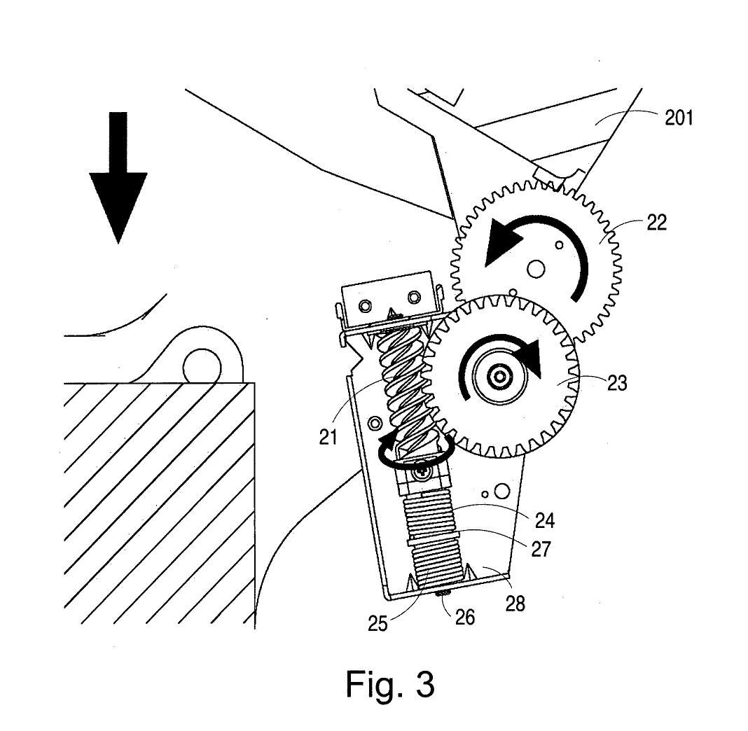

Please refer to FIG. 3, which is a partial enlargement view of FIG. 2. A control collar 27 is disposed between the first resistant torque providing element 24 and the second resistant torque providing element 25; the end of the first resistant torque providing element 24 close to the second resistant torque providing element 25 is fixed to the control collar 27, and the end of the second resistant torque providing element 25 close to the first resistant torque providing element 24 is fixed to the control collar 27. When the upper body 201 is to be closed and moved downwardly, the first gear 22 rotates in a counterclockwise direction and the second gear 23 rotates in a clockwise direction; meanwhile, the rotating element 21 is driven by the second gear 23 to rotate in a clockwise direction (as viewed from the top). In the mean time, the first resistant torque providing element 24 tightly wraps up the rotating element 21 and the control collar 27 under the first resistant torque providing element 24. The second resistant torque providing element 25 has a rotation direction counter to that of the first resistant torque providing element 24, so the second resistant torque provided by the second resistant torque providing element 25 is in a direction counter to that of the first resistant torque provided by the first resistant torque providing element 24. Thereby, the second resistant torque can counterbalance the rotating toque of the rotating element 21 and the first resistant torque, so that when the upper body 201 is moved downwardly, the huge torque generated from the heavy load on the first gear 22 will be reduced to a small torque through the continuous actions of the first gear 22, the second gear 23, the rotating element 21, the first resistant torque providing element 24 and the second resistant torque providing element 25. Accordingly, the support device can gradually dissolve the huge torque generated from the weight load of the upper body 201, so the upper body 201 can be stably supported and will not suddenly drop down.

On the contrary, when the upper body 201 is to be opened and moved upwardly, the rotating element 21 driven by the first gear 22 and the second gear 23 turns to rotate in a counterclockwise direction (as viewed from the top). Although the rotation directions of the first resistant torque and the second resistant torque provided by the first resistant torque providing element 24 and the second resistant torque providing element 25 are both counter to those in the closing process of the upper body 201, the first resistant torque and the second resistant torque still have counter rotation directions and can counterbalance to each other. Therefore, when the upper body 201 is to be opened, the support device can still support the upper body 201 stably.

In this embodiment, the first resistant torque providing element 24 and the second resistant torque providing element 25 are in a repellent conditions, no matter in the opening or the closing process of the upper body 201. As described above, in the closing process, the first resistant torque providing element 24 is in a lock status and the second resistant torque providing element 25 provides the resistant torque. While in the opening process, the second resistant torque providing element 25 is in a lock status and the first resistant torque providing element 24 provides the resistant torque. By a well mechanical design, the first and second resistant torques can be in different magnitudes. For example, a small resistant torque is provided during the opening process so that the user can easily open the upper body 201, and a large resistant torque is provided during the closing process so as to withstand the dropping force of the upper body 201.

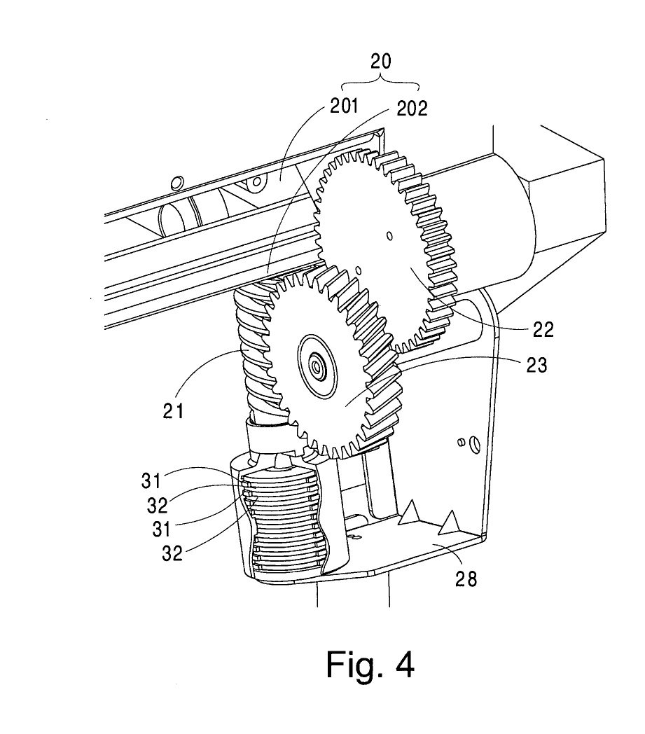

Please refer to FIG. 4, which is a schematic view showing the support device according to the second preferred embodiment of the present invention. As shown in FIG. 4, except the spring shown in FIGS. 2 and 3, the first resistant torque providing element 31 and the second resistant torque providing element 32 can be friction disks, and the plural first resistant torque providing element 31 and the plural second resistant torque providing element 32 are superimposedly and alternatively disposed. One of the first resistant torque providing element 31 and the second resistant torque providing element 32 is fixed to the axis of the rotating element 21, and the other is fixed to a supporting frame 28. Using the first resistant torque providing element 31 fixed to the rotating element 21 as an example, when the rotating element 21 rotates in a clockwise direction, the first resistant torque providing element 31 is also rotates in a clockwise direction. Since the first resistant torque providing element 31 and the second resistant torque providing element 32 are both friction disks, the first resistant torque, i.e. the frictional force, provided by the first resistant torque providing element 31 will counterbalance the second resistant torque provided by the second resistant torque providing element 32. Accordingly, the support device can gradually dissolve the huge torque generated from the weight load of the upper body 201, so the upper body 201 can be stably supported and will not suddenly drop down.

During the opening and closing processes of the upper body 201, different rotation directions are generated, and the directions and the magnitudes of the resulted axial component force are also different. Due to the difference of the axial component force, the friction disk system generates different frictional resistances, which are kind of resistant torques. That is to say, the support device provides two different resistant torques during the opening and closing processes. The user only needs to provide little force to open the upper body 201, and the support device provides large resistance to support the upper body 201 and prevent it from dropping down suddenly during the closing process.

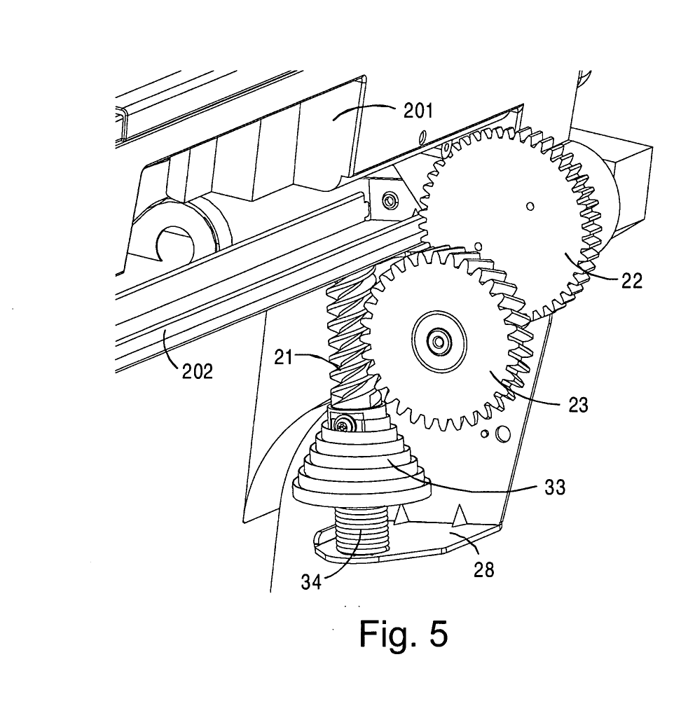

Please refer to FIG. 5, which is a schematic view showing the support device according to the third preferred embodiment of the present invention. As shown in FIG. 5, the first resistant torque providing element 33 is a spiral spring and the second resistant torque providing element 32 is a general spring. Compared to the first resistant torque providing element 24 shown in FIG. 2, the first resistant torque provided by the first resistant torque providing element 24 shown in FIG. 2 is a constant force, but the magnitude of the first resistant torque provided by the first resistant torque providing element 33 in this embodiment is in linear relationship with the opening angle of the upper body 201. In other words, the first resistant torque is adjustable according to the opening or closing angle of upper body 201 and the weight load. Even when the opening angle of the upper body 201 is very small, the support device can still provides sufficient resistant torque to stably support the upper body 201 and prevent it from dropping down suddenly.

All the examples of the first resistant torque providing element and the second resistant torque providing element described in the above embodiments can be interchanged to have various modifications. The examples are not used to confine the present invention, and any component that can generate the resistant torque can be used as the first resistant torque providing element and the second resistant torque providing element. In addition, a supporting frame 28 is provided under the rotating element for fixing and supporting the rotating element, the first resistant torque providing element and the second resistant torque providing element. Certainly, the assembling manners of each component are not limited, and the positions of the first resistant torque providing element and the second resistant torque providing element can be exchanged; the only requirement is that the first resistant torque providing element and the second resistant torque providing element provide resistant torques in counter directions to counterbalance to each other for dissolving the weight load of the upper body so as to further support the upper body.

In the embodiments of the present invention, the upper body can be an auto document feeder (ADF), an image input device, a dust cover, or the combinations thereof.

In conclusion, the support device of the present invention includes a gear train and resistant torque providing elements to gradually dissolve the weight load of the upper body during the opening or closing processes, so as to stably support the upper body of the electronic apparatus. Moreover, regardless of the opening or closing angle of the upper body, the support device can provide sufficient resistant torque to support the upper body and prevent it from dropping down suddenly, and thus, the stability and safety are increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A support device for supporting an upper body of an electronic apparatus, wherein said electronic apparatus further comprises a lower body, and said upper body pivotally rotates relative to said lower body, said support device comprising:
a rotating element disposed on said lower body and having a thread surface;
a first gear disposed on said upper body;
a second gear meshing with said first gear at one side and meshing with said thread surface of said rotating element at another side;
a first resistant torque providing element disposed under said rotating element; and
a second resistant torque providing element disposed under said first resistant torque providing element;
wherein said first resistant torque providing element and said second resistant torque providing element provide resistant torques in counter directions.

2. The support device according to claim 1 wherein said first gear and said second gear have counter rotation directions.

3. The support device according to claim 1 wherein said thread surface of said rotating element is a continuous thread surface.

4. The support device according to claim 1 wherein said first resistant torque providing element is a spring.

5. The support device according to claim 1 wherein said second resistant torque providing element is a spring.

6. The support device according to claim 1 further comprising a control collar.

7. The support device according to claim 6 wherein said control collar is disposed between said first resistant torque providing element and said second resistant torque providing element.

8. The support device according to claim 6 wherein an end of said first resistant torque providing element close to said second resistant torque providing element is fixed to said control collar.

9. The support device according to claim 6 wherein an end of said second resistant torque providing element close to said first resistant torque providing element is fixed to said control collar.

10. The support device according to claim 1 wherein said first resistant torque providing element is a friction disk.

11. The support device according to claim 1 wherein said second resistant torque providing element is a friction disk.

12. The support device according to claim 1 wherein said first resistant torque providing element and said second resistant torque providing element are superimposedly and alternatively disposed.

13. The support device according to claim 1 wherein said first resistant torque providing element is fixed to an axis of said rotating element.

14. The support device according to claim 1 wherein said second resistant torque providing element is fixed to an axis of said rotating element.

15. The support device according to claim 1 wherein said first resistant torque providing element or said second resistant torque providing element is a spiral spring.

16. The support device according to claim 1 further comprising a supporting frame disposed under said second resistant torque providing element.

17. The support device according to claim 1 wherein said upper body of said electronic apparatus is an auto document feeder, an image input device, or a dust cover.

18. The support device according to claim 1 wherein said upper body of said electronic apparatus is a combination of an auto document feeder, an image input device, or a dust cover.
